(19) United States
(12) Patent Application Publication
(10) Pub. No.: US 2024/0293725 A1
(43) Pub. Date: Sep. 5, 2024

(54) A GAME SCORING APPARATUS

(71) Applicant: Charles Francis Wilkie, McDowall (AU)

(72) Inventor: Charles Francis Wilkie, McDowall (AU)

(21) Appl. No.: 17/999,489

(22) PCT Filed: May 26, 2021
(86) PCT No.: PCT/AU2021/050499

§ 371 Date: Nov. 21, 2022

(30) Foreign Application Priority Data
May 26, 2020 (AU) 2020901705

(51) Int. Cl. A63B 71/06; A63F 11/00

(52) U.S. Cl. CPC A63B 71/0669; A63F 11/0051; A63F 2011/0058

(57) ABSTRACT

A game scoring apparatus, wherein the game scoring apparatus comprises an audio input configured to receive input speech signals. The game scoring apparatus also comprises a processor configured to process digital data and convert the speech signals into data for game scoring information. Furthermore, the game scoring apparatus comprises a physical input interface and a display is configured to display game scoring information. Parameters of the game scoring information can be input using both the audio input and the physical input interface. The game scoring apparatus enables efficient electronic game scoring of a match or fixture through voice recognition and speech input.

### CROSS-REFERENCE TO RELATED APPLICATIONS

This application is a national stage of, and claims priority to, Patent Cooperation Treaty Application No. PCT/AU2021/050499, filed May 26, 2021, which application claims priority to Australian Provisional Application No. 2020901705, filed May 26, 2020, which applications are hereby incorporated by reference in their entireties.

### FIELD OF THE DISCLOSURE

This disclosure relates generally to autonomous computer scoring game tracking systems. More particularly, this disclosure relates to an autonomous speech signal recognition game scoring system.

### BACKGROUND

Scoring of sporting matches and games typically entails manual score keeping by an off-field scorer. However, scorers are not always available for all sporting events, especially non-professional sporting events.

Whereas the umpire/referee of the sporting match may keep score, that can be non-ideal as the umpire/referee generally cannot be distracted, such as by taking his or her eyes off gameplay for input of data into a portable computing device, for example.

In certain sporting and gaming events, such as Basketball and Ice Hockey, the umpire/referee may issue hand score signals, which require interpretation by an off-field scorer.

Furthermore, it may not be practical to have a sporting event adjudication/support team consisting of a high number of personnel. This may be due to limitations of cost, or during situations where social distancing is required and operating personnel for sporting events should be minimised.

There is therefore a need for an improved scoring system.

It is to be understood that, if any prior art information is referred to herein, such reference does not constitute an admission that the information forms part of the common general knowledge in the art, in Australia or any other country.

### OBJECT OF THE DISCLOSURE

It is a preferred object of the disclosure to provide apparatuses and/or systems and/or methods that address or ameliorate one or more of the aforementioned problems of the prior art and/or provide a useful commercial alternative.

### SUMMARY OF THE DISCLOSURE

The present disclosure relates to a game scoring apparatus for semi or fully autonomous scoring of matches that uses speech signal recognition in a way that allows an umpire/referee to score the match without being unduly distracted such as by having to take their eyes off game play. The game scoring apparatus may also reduce or eliminate the need for additional scorers and/or time keepers in certain sporting events.

In one form, although not necessarily the broadest form, the disclosure relates to a game scoring apparatus, wherein the game scoring apparatus comprises: an audio input configured to receive input speech signals; a processor configured to process digital data and convert the speech signals into data for game scoring information; a physical input interface; and a display configured to display game scoring information; wherein parameters of the game scoring information can be input using both the audio input and the physical input interface.

Preferably, the game scoring apparatus further comprises an audio output configured to send voice confirmations.

Further preferably, the audio output comprises an output hardware device.

Preferably, the data for game scoring information comprises hexadecimal, ascii, or numeric values.

Preferably, the display comprises an e-paper screen and/or LCD screen.

Preferably, the display further displays input confirmation of parameters of the game scoring information.

Preferably, the physical input interface comprises one or more of: joystick, button, slide switch, and touch pad.

Further preferably, the physical input interface allows selection of a particular team to which input of the game scoring information is to be applied.

Preferably, the game scoring apparatus further comprises an external headset connection.

Further preferably, the external headset connection is a wireless headset transceiver.

Further preferably, the wireless headset transceiver connects the game scoring apparatus to a wireless headset.

Further preferably, the wireless headset is configured to receive the input speech signals and/or output the game scoring information by text and/or audio.

Preferably, the game scoring apparatus further comprises a wireless data transceiver, the wireless data transceiver configured to at least transmit the data for game scoring information to a third-party software and/or device.

Preferably, the game scoring apparatus further comprises at least one cable connection or wireless connection interface for com port connection and/or charging of a battery powering the game scoring apparatus.

Preferably, the game scoring apparatus further comprises one or more vibration motors to provide haptic feedback.

Preferably, the game scoring apparatus comprises an automatic speech recognition decoder for classifying input speech signals as one or more spoken signals.

Preferably, the game scoring apparatus comprises a signal command dictionary comprising a finite set of signal commands.

Preferably, the game scoring apparatus is a hand-held device.

### BRIEF DESCRIPTION OF THE DRAWINGS

To assist in understanding the disclosure and to enable a person skilled in the art to put the disclosure into practical effect, a preferred example of the disclosure will be described by way of example only with reference to the accompanying drawings, in which:

FIG. 1 is a perspective view of a game scoring apparatus, according to an example of the present disclosure.

FIG. 2 is a diagrammatic illustration of the game scoring apparatus of FIG. 1, and internal components.

FIG. 3 is a side view of the game scoring apparatus of FIG. 1, embodied with a joystick.

FIG. 4 is a diagrammatic illustration of the game scoring apparatus of FIG. 1, paired to an external headset.

FIG. 5 is a diagrammatic illustration of the game scoring apparatus of FIG. 1, paired to a third-party system.

FIG. 6 is a diagrammatic illustration of a further example of the game scoring apparatus of FIG. 1, with alternative paring options.

### DETAILED DESCRIPTION OF THE DISCLOSURE

The present disclosure relates to a game scoring apparatus which recognises speech signals from an umpire/referee so that game scoring information may be processed and recorded. Elements of the disclosure are illustrated in concise outline form in the drawings, showing only those specific details that are necessary to understanding the examples of the present disclosure, but so as not to clutter the disclosure with excessive detail that will be obvious to those of ordinary skill in the art in light of the present description.

According to one aspect, the present disclosure is defined as a game scoring apparatus, wherein the game scoring apparatus comprises an audio input configured to receive input speech signals, a processor configured to process digital data and convert the speech signals into data for game scoring information, a physical input interface, and a display configured to display game scoring information, wherein parameters of the game scoring information can be input using both the audio input and the physical input interface.

Advantages of some examples of the present disclosure include the ability to allow an umpire/referee to score a game without being unduly distracted such as by having to take their eyes off game play. During the course of a game or match, an umpire/referee is able to verbally umpire and referee the game play. The game scoring apparatus receives the input speech signals and registers the input speech signals as game scoring information. These may include game scoring information such as points awarded, points deducted, fouls, penalties, substitutions, and changes to players or game time. The umpire may also manipulate a physical input interface to direct the input speech signal towards a team, player, or aspect of game play. The game scoring information will be presented on a display so that the game scoring information is visually represented, and any input speech signals visually confirmable by the umpire/referee. The umpire/referee may also receive a voice signal confirming the recognised input speech signal and commands relating to game scoring information.

Those skilled in the art will appreciate that not all of the above advantages are necessarily included in all examples of the present disclosure.

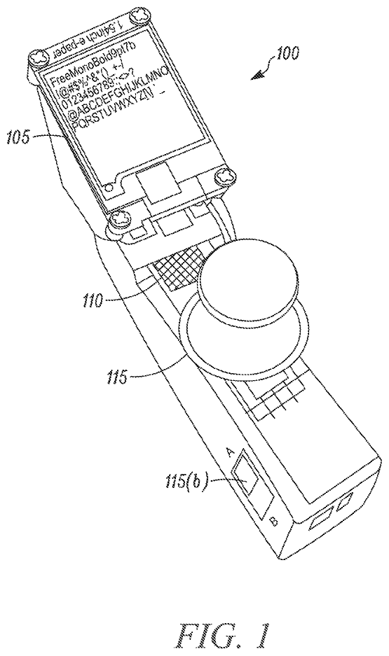

FIG. 1 is a perspective view of a game scoring apparatus 100, according to a preferred example of the present disclosure. Shown as a hand-held device with a display 105, the game scoring apparatus 100 is able to display game scoring information as inputted by an umpire/referee. Game scoring information may be inputted through input speech signals received by an audio input 110 and/or through a physical input interface 115 such as a joystick. The skilled addressee will understand that the display 105 may comprise suitable hardware such as e-paper or LCD screens. Depending on contextual requirements, the skilled addressee would also understand that e-paper may be advantageous as e-paper displays are less likely to reflect glare in a bright outdoor setting. Conversely, an LCD screen may provide more readability in a low light indoor setting. Further, the skilled addressee will understand that the game scoring apparatus 100 may comprise further input mechanisms 115(b) for manipulating input including, but not limited to, buttons, slide switches, and touch pads.

In a preferred example, the further input mechanism 115(b) is a single slide switch with two selectors A and B. The selectors A and B are mapped to select input mechanisms, with the further input mechanism 115(b) in the A position which is mapped to utilise the onboard audio input 110, such as an onboard far field microphone. The skilled addressee will understand that the further input mechanism 115(b) may also be mapped or configured to augment the use of the physical input interface 115 and/or toggle different pre-set configurations of the game scoring apparatus 100 according to umpire/referee user preferences. For example, further input mechanism 115(b) in the B position may toggle the selection of a wireless microphone.

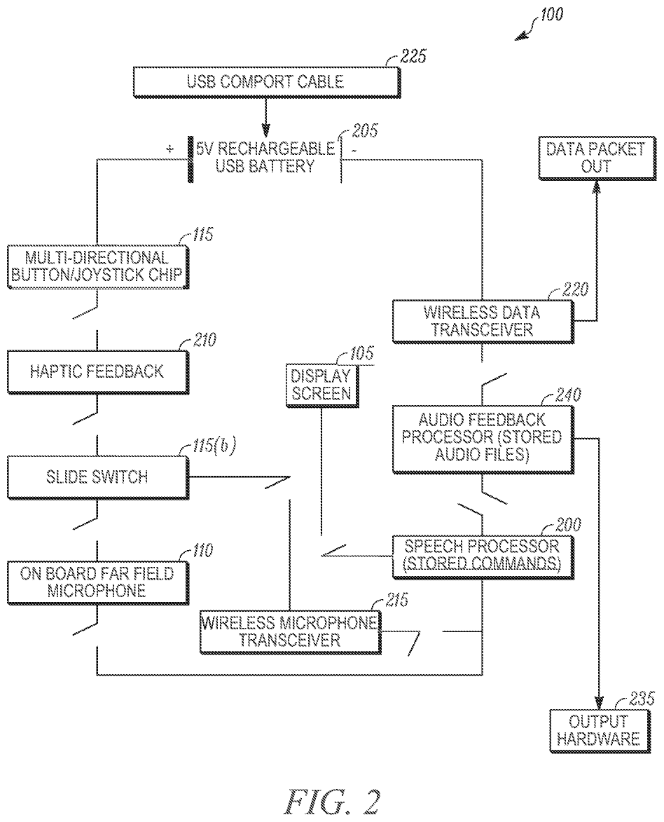

FIG. 2 is a diagrammatic illustration of the game scoring apparatus 100 of FIG. 1, and internal components including a speech processor 200 configured to process digital data and convert the speech signals into data for game scoring information, a battery 205 for powering the game scoring apparatus, a vibration motor 210 for providing haptic feedback, a wireless transceiver 215 for connection to an external headset 230, a wireless data transceiver 220 to at least transmit data for game scoring information, an output hardware device 235 for providing voice signal confirmation of speech commands, and wireless connection or cable connection interface 225 for com port connection and/or charging of the battery 205. The person skilled in the art will understand that wireless or wired connections (such as a USB receiver/transceiver) can be utilised depending on contextual need and situational requirement.

The processor 200 is configured to process digital data and convert the inputted speech signals into data for game scoring information. In a preferred example, the game scoring apparatus comprises an automatic speech recognition decoder for classifying input speech signals as one or more spoken signals. Preferably, the game scoring apparatus 100 comprises a signal command dictionary comprising a finite set of signal commands.

The input speech signals are converted into data for game scoring information as a hexadecimal, ascii, or numeric result set. The hexadecimal, ascii, or numeric result set is translated and presented on the display 105 as readable text according to the umpire/referee's preferred language, communicating game scoring information. In a further preferred example, the display also displays confirmation of input from the umpire/referee, providing visual feedback that the correct speech signal is received by the game scoring apparatus 100. Confirmation or feedback of input can also optionally be communicated by haptic feedback through operation of the vibration motor 210. Further optionally, confirmation or feedback of input can be communicated as voice signal confirmation. This voice signal confirmation may be delivered through an audio feedback processor 240 which provides the voice signal confirmation through the output hardware device 235. The audio feedback processor 240 and the output hardware device 235 may be dedicated to delivering voice signal confirmations using stored audio files. The output hardware device 235 may be an onboard speaker or, preferably, an audio earpiece. The skilled addressee will understand that feedback methods can be solely or a combination of visual, audio, and haptic feedback according to user preference and setting.

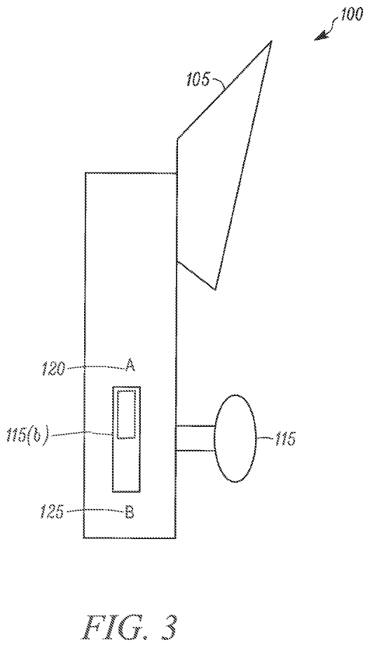

FIG. 3 is a side view of the game scoring apparatus 100 of FIG. 1, embodied with a joystick as the main physical input interface 115 and a slide switch as the further input mechanism 115(b). In a preferred example, the umpire/referee may assign a joystick direction to be associated with a particular team. When the joystick is engaged in the assigned direction, the inputted speech signals are also applied towards the respective team. In this manner, the umpire/referee may speak to award points or score towards a first team when the joystick is in the up direction, and speak to award points or score towards a second team when the joystick is in the down direction. The further input mechanism 115(b), shown as a slide switch, can select between settings A 120 and B 125. The further input mechanism 115(b) may be configured so that setting A 120 elects the use of the onboard audio input 110 for speech signal input and setting B 125 elects the use of the wireless microphone 215 and/or wireless headset 230 for speech signal input. The skilled addressee will understand that audio input selection may be dependent upon a given situation and user preference, that the number of teams is dependent upon particular games, and that selection of a team may be followed with different commands for scoring or issuing of information depending on context of a particular sport or game. Non-team specific commands can also be issued when the joystick is in a neutral position and no team is selected for the issuance of a command.

Optionally, the physical input interface 115 can comprise one or more of a joystick, buttons, slide switches, and touch pads. These physical input interface 115 can be likewise mapped or configured to be associated with a particular team, or aspect of game play, depending on game configuration.

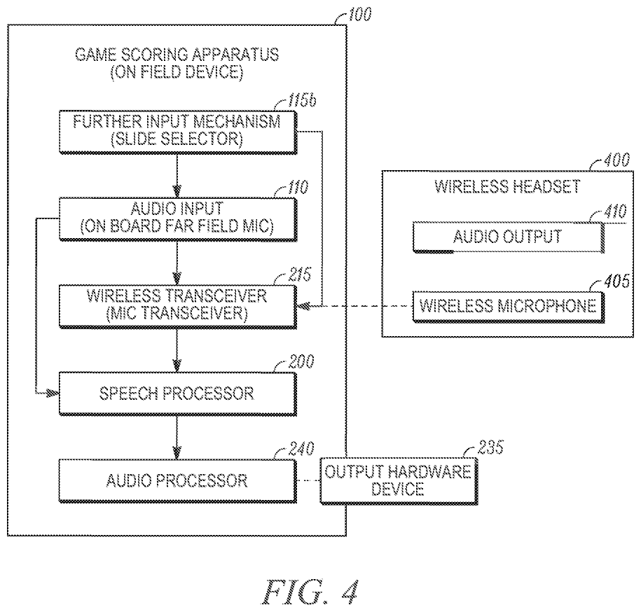

FIG. 4 is a diagrammatic illustration of the game scoring apparatus 100 of FIG. 1, paired to an external headset 400 comprising a wireless microphone 405. In a preferred example, the wireless microphone 405 is connected to the game scoring apparatus 100 via the wireless microphone transceiver 215 of FIG. 2. In a further preferred example, the wireless microphone transceiver 215 allows Bluetooth connection between the game scoring apparatus 100 and the wireless microphone 405. The skilled addressee will understand that alternate forms of wired and/or wireless connection can be implemented depending on contextual limitations or requirements, such as distance and hardware compatibility. Optionally, the external headset 400 may provide both audio output 410 and input depending on need.

Preferably, the wireless microphone 405 is used to issue commands providing the input speech signal received by the game scoring apparatus. Speech signals inputted in through the wireless microphone 405 can also be processed by the processor 200 and converted into hexadecimal, ascii, numeric data as data for game scoring information. Input speech signals through the wireless microphone 405 can also be manipulated by the physical input interface 115 or any further input mechanisms 115(b), applying an input speech signal to a particular team, player, or aspect of gameplay. The skilled addressee will understand that particular examples will include various hardware configurations and button mappings dependent upon the requirements of a particular game, sport, or rule set.

Optionally, the connected external headset 400 comprises at least one audio output component 410 so that game scoring information is both provided as text on the display 105 and also as audible text to audio confirmation through the audio output component 410. Further optionally, the audio feedback processor 240 and output hardware device 235 in the form of an audio carpiece may be set to consistently deliver voice signal confirmation after each voice command input given by the referee/umpire. For example, when the on board far field mic is selected and a wireless headset 400 is not used, the umpire/referee may still receive confirmation or information via the output hardware device 235. The skilled addressee will understand that confirmation of input may be text and/or audio feedback or other forms of audible feedback.

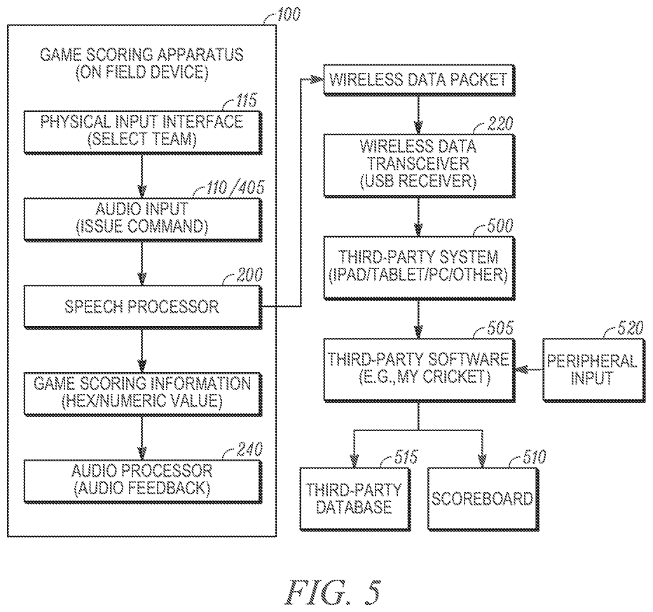

FIG. 5 is a diagrammatic illustration of the game scoring apparatus 100 of FIG. 1, paired to a third-party system 500 via the wireless data transceiver 220 which can transfer wireless data to a USB receiver connected to the third-party system 500. The third-party system 500 may comprise one or more independent or linked devices, such as iPads, tablets, computers, or other electronic devices. The game scoring apparatus 100 will allow the umpire/referee to select a team using the physical input interface 115, issue game scoring information through input speech signals received by the audio input 110 or the external headset 405, allow the processor 200 to convert the inputted speech signals into data, and deliver the data, preferably as hexadecimal, ascii, or numeric value, to the third-party system 500 via the wireless data transceiver 220.

In a preferred example, the third-party system 500 is a computer comprising a third-party software 505 tailored towards a particular game, sport, match, and/or ruleset. Optionally, the third-party system 500 can then be connected to a further external display 510 such as a score board. The skilled addressee will understand that while the game scoring apparatus 100 is capable of operating as an independent in-field device, connection to a third-party system 500 may facilitate record keeping of game scoring information and/or transfer of game scoring information to an external display 510 to provide further visual updates to spectators of a game or match. The third-party software 505 may also comprise its own database 515 for record keeping of game scoring information, and the third-party system 500 may also comprise any other ancillary hardware, such as keyboards or peripheral input devices 520, as required for operation.

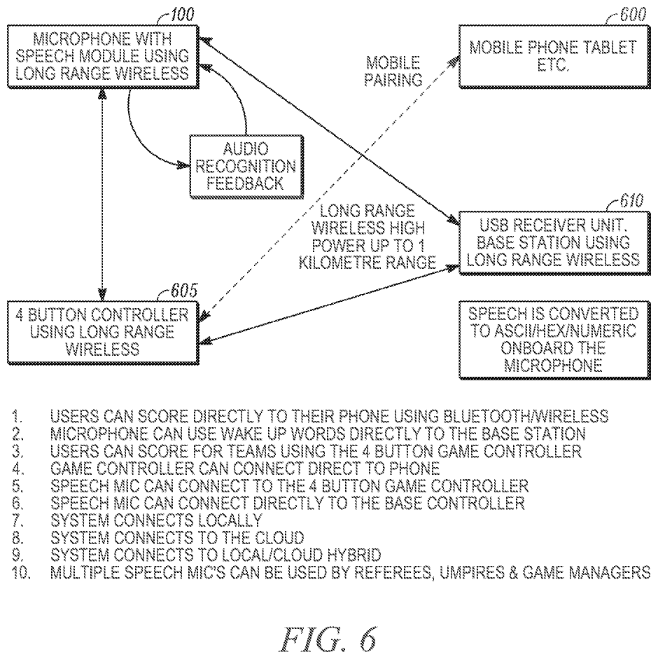

FIG. 6 is a diagrammatic illustration of a further example of the game scoring apparatus 100 of FIG. 1, with alternative paring options, connected to various input and output devices paired via at least the wireless microphone transceiver 215. As previously discussed, the wireless headset 400 may also be connected to the game scoring apparatus 100 via Bluetooth or other wireless systems. Accordingly, a suitable mobile phone or device 600 may be paired to the game scoring apparatus 100 as a scoring input device, as well as a feedback device. Optionally, the connected mobile phone or device 600 may also replicate the interface of display 105 so that scoring information is displayed. The person skilled in the art will understand that further types of Bluetooth devices are available for paring with the game scoring apparatus 100, such as generic controllers 605 commonly used for gaming. These generic controllers 605 are often four-button in format, suitable for pairing with different devices, platforms, or gaming consoles, and are also likewise connectable and configurable to be suitable for use with the game scoring apparatus 100. Further optionally, wireless connection between devices may be long range and high power so that large distances may be covered. The person skilled in the art will understand that this may or may not be necessary depending on the game or match, as fixture areas may range from small indoor courts to large stadiums, circuits, and tracks.

In a further example, multiple mobile phones or devices 600 including generic controllers 605 may be employed by multiple umpires/referees and/or game mangers to score and/or monitor a game or match. Accordingly, the different devices 600 and controllers 605 may be interconnected via a cloud system or base station 610 to boost and/or ensure connectivity. This allows multiple umpires/referees to assist with scoring of games or matches across a large sporting field. The person skilled in the art will understand that this arrangement may be implemented as needed according to sport, for personnel such as linesmen, bowler's/striker's end umpires, central/boundary/goal umpires, and line/field/side/back judges.

The game scoring apparatus 100 therefore addresses at least some of the aforementioned problems, providing a convenient stand-alone hand-held apparatus that allows one or more umpires/referees to score a game through voice recognition and speech input. The game scoring apparatus 100 allows the umpire/referee to independently score and time a game so that the need for additional score keepers or time keepers are minimised or eliminated.

The game scoring apparatus 100 also allows the umpire/referee to visually track scorekeeping through a display 105, or to transmit the data for game scoring information as hexadecimal, ascii, or numeric values to a third-party system 500 and/or software 505. This reduces the number of score-keeping personnel required to adequately umpire and score a game or match without distracting the umpire/referee with additional tasks such as manually scoring a game or match. This also allows a reduction of personnel and staff required to run a game when cost limitations or social distancing requirements are considered. The skilled addressee will understand that the game scoring apparatus 100 can therefore be a valuable tool for umpires/referees in small or large scale sporting events including, but not limited to, Basketball, Ice Hockey, Australian Football League (AFL), Cricket, National Football League (NFL), Soccer, Fencing, and various martial arts.

In this patent specification, adjectives such as first and second, left and right, top and bottom, up and down, upper and lower, rear, front and side, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular example of the present disclosure.

The above description of various examples of the present disclosure is provided for purposes of description to one of ordinary skill in the related art. It is not intended to be exhaustive or to limit the disclosure to a single disclosed example. Numerous alternatives and variations to the present disclosure will be apparent to those skilled in the art of the above teaching. Accordingly, while some alternative examples have been discussed specifically, other examples will be apparent or relatively easily developed by those of ordinary skill in the art. Accordingly, this patent specification is intended to embrace all alternatives, modifications and variations of the present disclosure that have been discussed herein, and other examples that fall within the scope of the above described disclosure, which is determined by the following claims.

1-18. (canceled)

19. A game scoring apparatus, comprising:
an audio input configured to receive input speech signals;
a processor configured to process digital data and convert the speech signals into data for game scoring information;
a physical input interface; and
a display configured to display game scoring information that is input using both the audio input and the physical input interface.

20. The game scoring apparatus of claim 19, wherein the game scoring apparatus further comprises an audio output configured to send voice confirmations.

21. The gaming scoring apparatus of claim 20, wherein the audio output comprises an output hardware device.

22. The game scoring apparatus of claim 19, wherein the data for game scoring information comprises hexadecimal, ascii, or numerical values.

23. The game scoring apparatus of claim 19, wherein the display comprises an e-paper screen or LCD screen.

24. The game scoring apparatus of claim 19, wherein the display further displays input confirmation of parameters of the game scoring information.

25. The game scoring apparatus of claim 19, wherein the physical input interface comprises one or more of: joystick, button, slide switch, and touch pad.

26. The game scoring apparatus of claim 25, wherein the physical input interface allows selection of a particular team to which input of the game scoring information is to be applied.

27. The game scoring apparatus of claim 19, wherein the game scoring apparatus further comprises an external headset connection.

28. The game scoring apparatus of claim 27, wherein the external headset connection is a wireless headset transceiver.

29. The game scoring apparatus of claim 28, wherein the wireless headset transceiver connects the game scoring apparatus to a wireless headset.

30. The game scoring apparatus of claim 29, wherein the wireless headset is configured to receive the input speech signals and/or output the game scoring information by text and/or audio.

31. The game scoring apparatus of claim 19, wherein the game scoring apparatus further comprises a wireless data transceiver, the wireless data transceiver configured to at least transmit the data for game scoring information to a third-party software and/or device.

32. The game scoring apparatus of claim 19, wherein the game scoring apparatus further comprises at least one cable connection or wireless connection interface for com port connection and/or charging of a battery powering the game scoring apparatus.

33. The game scoring apparatus of claim 19, wherein the game scoring apparatus further comprises one or more vibration motors to provide haptic feedback.

34. The game scoring apparatus of claim 19, wherein the game scoring apparatus comprises an automatic speech recognition decoder for classifying input speech signals as one or more spoken signals.

35. The game scoring apparatus of claim 19, wherein the game scoring apparatus comprises a signal command dictionary comprising a finite set of signal commands.

36. The game scoring apparatus of claim 19, wherein the game scoring apparatus is a hand-held device.
